(19) United States
(12) Patent Application Publication
(10) Pub. No.: US 2026/0062085 A1
(43) Pub. Date: Mar. 5, 2026

(54) METHODS AND SYSTEMS FOR DRIVER BEHAVIOR MONITORING AND INTERVENTION

(71) Applicant: Leigh M. Rothschild, Miami, FL (US)

(72) Inventor: Leigh M. Rothschild, Miami, FL (US)

(21) Appl. No.: 18/816,930

(22) Filed: Aug. 27, 2024

(51) Int. Cl. B62J 50/22; B62J 45/20; B62J 45/412; B62J 45/414

(52) U.S. Cl. CPC B62J 50/22; B62J 45/20; B62J 45/412; B62J 45/414

(57) ABSTRACT

According to aspects illustrated herein, methods and systems for driver behavior monitoring and intervention are disclosed. The method includes capturing vehicle-related data and driver-related data pertaining to a two-wheeled vehicle and a driver operating the two-wheeled vehicle, respectively, and analysing vehicle-related data to detect commencement of a trip by the driver. The method further includes, processing the driver-related data to identify one or more driver attributes associated with unsafe driving behavior, based on one or more predefined rules, and sending an alert to the driver upon the identification of the driver attributes. The alert comprises recommendations for corrective measures for the driver to be implemented within a pre-determined time period. The alert further comprises a notification indicating that preventive actions will be initiated if the corrective measures are not implemented. The method further includes executing the preventive actions if the driver does not implement the corrective measures.

### TECHNICAL FIELD

The present disclosure relates to the field of vehicles, more specifically, the disclosure discloses methods and systems for monitoring behavior of a driver operating a two-wheeled vehicle and implementing preventive actions for the driver based on the behavior of the driver.

### BACKGROUND

With the increasing prevalence of two-wheeled vehicles on roadways, significant concerns about road safety have arisen. Unsafe driving behavior not only puts the driver at risk but also poses a serious threat to all other road users. Behaviors such as aggressive driving, tailgating, reckless lane changes, speeding, neglecting to wear a helmet, and distracted driving are prominent contributors to the alarming rate of road accidents and fatalities. Past efforts to address these issues have predominantly relied on conventional approaches including enforcing traffic regulations, improving road infrastructure, conducting public awareness campaigns, and implementing warning systems in two-wheeled vehicles. However, these efforts have not fully addressed the unique challenges posed by the increasing prevalence of two-wheeled vehicles. For instance, conventional warning systems often employ elementary indicators such as speed limits or auditory alerts, which may lose effectiveness over time, particularly if these warnings become frequent occurrences during routine driving scenarios. In many cases, drivers tend to ignore warnings from their own vehicles, assuming they know better or believing that the warnings are false alarms. Such negligence not only endangers their own safety but also poses a threat to the fellow road users. To address these shortcomings, advanced methods and systems are needed that are capable of promptly detecting and reporting instances of unsafe driving in real-time. By promptly detecting and reporting instances of unsafe driving in real-time, appropriate actions can be taken, thereby enhancing the overall road safety.

### SUMMARY

According to aspects illustrated herein, methods and systems for driver behavior monitoring and intervention are disclosed. The method includes capturing vehicle-related data and driver-related data pertaining to a two-wheeled vehicle and a driver operating the two-wheeled vehicle, respectively. The captured vehicle-related data is analyzed to detect commencement of a trip by the driver of the two-wheeled vehicle. Upon detection of the commencement of the trip by the driver of the two-wheeled vehicle, the driver-related data is processed to identify one or more driver attributes associated with unsafe driving behavior, based on one or more predefined rules. The method further includes sending an alert to the driver upon the identification of the one or more driver attributes. The alert includes recommendations for one or more corrective measures for the driver to be implemented within a pre-determined time period. The alert further includes a notification indicating that one or more preventive actions will be initiated if the one or more corrective measures are not implemented by the driver within the pre-determined time period. The one or more preventive actions are executed if the one or more corrective measures are not implemented by the driver within the pre-determined time period.

According to additional aspects, the disclosure discloses a system for driver behavior monitoring and intervention. The system includes a plurality of sensors to capture vehicle-related data and driver-related data pertaining to a two-wheeled vehicle and a driver operating the two-wheeled vehicle, respectively. The system further includes a data analysis unit to analyze the captured vehicle-related data to detect commencement of a trip by the driver of the two-wheeled vehicle. The system also includes a driver attributes identification unit to process the driver-related data to identify one or more driver attributes associated with unsafe driving behavior, based on one or more predefined rules. Further, the system includes a communication unit to send an alert to the driver upon the identification of the one or more driver attributes. The alert includes recommendations for one or more corrective measures for the driver to be implemented. The alert further includes a notification indicating that one or more preventive actions will be initiated if the driver does not implement the one or more corrective measures. The system also includes a preventive action unit to ascertain, after a preset time duration has elapsed, whether the driver has implemented the one or more corrective measures. The preventive action unit further executes the one or more preventive actions upon ascertaining that the driver has not implemented the one or more corrective measures.

According to additional aspects, the communication unit, upon ascertaining that the driver has not implemented the one or more corrective measures, sends an alert to a guardian of the driver to notify the guardian about unsafe driving behavior of the driver. The alert comprises detailed analysis report pertaining to the one or more driver attributes associated with unsafe driving behavior. The communication unit further transmits the captured vehicle-related data and the driver-related data pertaining to the two-wheeled vehicle and the driver of the two-wheeled vehicle, respectively, to a remote server for analysis, processing, and/or use.

The objective of the present disclosure is to provide methods and systems to enhance safety for drivers of two-wheeled vehicles by monitoring their behavior and implementing preventive actions to address unsafe driving practices. The methods and systems aim to mitigate road accidents, safeguard lives, and contribute to a safer transportation environment for all road users. The system utilizes a plurality of sensors installed on the two-wheeled vehicle to capture both vehicle-related data (such as speed, acceleration, and location) and driver-related data (including lane deviation frequency, neglecting to wear protective gear, and engagement with distracting devices). Upon detecting unsafe driving behaviors based on predefined rules, the system alerts the driver highlighting the observed risks and suggesting actionable corrective measures. If the driver fails to comply, the system initiates preventive actions, such as automatic braking or notifying interested parties, such as law enforcement authorities, a guardian (for example, a parent) or any other interested party. The execution of pre-emptive actions prevents potential accidents and promote responsible driving habits. The system sends an alert to the interested parties to notify them about the unsafe driving behavior of the driver, thereby providing a robust safety framework, particularly for young or inexperienced drivers. Furthermore, the system allows for remote monitoring and analysis by transmitting captured sensor data to a remote server, enabling comprehensive analysis and targeted interventions to enhance driver behavior on a large scale. The proposed methods and systems offer real-time feedback, customizable alerts, and proactive preventive actions to enhance safety and promote responsible driving habits among drivers of two-wheeled vehicles.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments, and together with the description, serve to explain the disclosed principles.

The illustrated embodiments of the present application will be best understood by reference to the drawings, wherein like parts are designated by like numerals throughout. The following description is intended only by way of example, and simply illustrates certain selected embodiments of devices, systems, and methods that are consistent with the subject matter as claimed herein.

FIG. 1A shows an exemplary environment in which various embodiments of the disclosure can be practiced.

FIG. 1B shows a block diagram of an overall system for monitoring behavior of a driver operating a two-wheeled vehicle and implementing preventive actions for the driver.

FIG. 2 depicts the driver operating the two-wheeled vehicle without wearing a helmet.

FIG. 3 shows an example of an alert displayed to the driver of the two-wheeled vehicle in response to detecting that the driver is not wearing a helmet while operating the two-wheeled vehicle.

FIG. 4 illustrates a text message displayed on a mobile device of a guardian of a driver responsive to ascertaining that the driver has not implemented the one or more corrective measures.

FIG. 5 is a method flowchart for monitoring behavior of a driver operating a two-wheeled vehicle and implementing preventive actions for the driver.

Like reference numerals refer to like parts throughout the several views of the drawings.

### DESCRIPTION

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “two-wheeled vehicle” refers to any vehicle that is designed to be operated on the road with only two wheels. The two-wheeled vehicle may be, but not limited to, a motorcycle and an electric scooter. A person can use the two-wheeled vehicle to commute from point A to point B. In context of the current disclosure, the two-wheeled vehicle incorporates a novel system for implementing preventive actions for monitoring behavior of a driver operating a two-wheeled vehicle and implementing preventive actions for the driver. Such vehicles are still considered “two-wheeled vehicles” even with the addition of an accessory carrier, such as a side car or trailer, which would increase the number of wheels to be greater than two.

The term “commencement of a trip” refers to the beginning or start of a journey undertaken by a driver of a two-wheeled vehicle. It typically indicates the moment when the driver initiates movement of the two-wheeled vehicle with the intention of traveling from one location to another location. This initiation of the movement of the two-wheeled vehicle signifies the beginning of a travel activity, during which the driver operates the two-wheeled vehicle to reach a destination.

The term “driver attributes” refers to specific characteristics or behaviors exhibited by a driver operating two-wheeled vehicle that contribute to either safe or unsafe driving practices. The driver attributes provide insights into the driving style, driving habits, and potential risks associated with the behavior of the driver. Examples of driver attributes include, but are not limited to, lane deviation frequency, speeding, disobeying traffic signs, response time to traffic signals, adherence to traffic rules, engagement with distracting devices, and use of protective gear.

The term “unsafe driving behavior” refers to any driving activities, driving behaviors, or a combination of both that are inherently dangerous, pose risks to society, and/or violate laws. Few non-limiting examples of the unsafe driving behavior may include, but are not limited to, aggressive driving, exhibiting road rage, tailgating, reckless lane changes, excessive speeding, neglecting to wear protective gear, distracted driving, impaired driving, unlawful activity, or the like.

The term “predefined rules” refer to rules that are already defined by a guardian of a driver, an administrator, a local or state government, authorized agencies, or automatically generated by the system to identify unsafe driving behavior. The predefined rules can be updated as and when required. The predefined rules refer to a criteria or guidelines that serve as a basis for identifying unsafe driving behavior from the driver-related data. The predefined rules outline specific parameters or thresholds for various driver attributes, such as lane deviation frequency, disobeying traffic signs, response time to traffic signals, improper lane filtering, or engagement with distracting devices, which indicate potentially hazardous behavior.

The term “alert” refers to a notification or warning sent to the driver of the two-wheeled vehicle, the guardian of the driver, and/or any other interested party. The alert typically includes information detailing the specific unsafe driving behaviors observed, as well as instructions or recommendations for corrective actions to be implemented by the driver. In an example, the alert may be a text alert, a visual alert, or an audible alert.

The term “pre-determined time period” may refer to the specific duration within which the driver is expected to implement one or more corrective measures after receiving an alert. In examples, the pre-determined time period can range from 10 seconds to 5 minutes, depending on the urgency of the situation and the severity of the detected driver behavior. This variability ensures that the driver has adequate time to address the issue promptly while prioritizing safety.

The term “preset time interval” may refer to a duration of time that has been predetermined or preestablished. The preset time interval indicates a specific period of time that must pass before it is checked whether the driver has implemented corrective measures or not. The time interval may be set based on the system's requirements and parameters. In example, the preset time interval may be seconds or minutes.

The term “preventive actions” can include one or more actions that can be taken to protect the two-wheeled vehicle and/or the driver of the two-wheeled vehicle from unsafe driving behavior of the driver and/or from obstacles surrounding the two-wheeled vehicle. The preventive actions are aimed at preventing accidents, injuries, and fatalities resulting from irresponsible or reckless driving practices of the driver. For example, a preventive action may be reducing vehicle speed to bring the vehicle to a controlled stop. Another example of a preventive action may be automatic braking.

The term “guardian” refers to an individual designated to oversee or supervise the driver of the two-wheeled vehicle, particularly in situations where the driver may be unable or unwilling to adhere to safety guidelines or corrective measures. In examples, the guardian may be a parent, a legal guardian, or any responsible party entrusted with the well-being and safety of the driver. Guardians are considered “interested parties” for purposes of the claims unless specifically claimed as a “guardians.”

### Overview

To address the pressing need for enhanced road safety measures amidst a growing population and technological advancements, the present disclosure is proposed that discloses a comprehensive solution for monitoring, alerting, and responding to unsafe driving behavior. The present disclosure discloses a novel driver risk mitigation system, which is technologically advanced and capable of accurately monitoring behavior of a driver operating a two-wheeled vehicle, alerting the driver in case of unsafe driving behavior, and taking appropriate actions in real-time.

The disclosed systems and methods provide a comprehensive approach for monitoring driver behavior. Utilizing a plurality of sensors and algorithms, the systems and methods collect data related to the driver's behavior, such as speed, acceleration, braking, lane changes, and other relevant behaviors. The systems and methods employ machine learning and Artificial intelligence algorithms to detect instances of unsafe driving behavior of the driver. The unsafe driving behavior refers to behaviors or actions that significantly increase the likelihood of accidents or collisions. Examples of unsafe driving behavior include but are not limited to activities like rash driving, excessive speeding, sudden lane changing, or distracted driving. Upon detection of the unsafe driving behavior, the systems and methods promptly alert the driver, aiming to mitigate risks and enhance awareness.

Beyond mere detection, the disclosed system is designed to take proactive measures in response to unsafe driving behavior of the driver. This may include dynamically adjusting vehicle settings or controls to optimize safety parameters. For instance, in cases of detected excessive speeding or sudden maneuvers, the system can initiate automatic speed reduction and/or emergency braking to prevent potential accidents. Moreover, the system can notify interested parties, such as guardians, relevant authorities, or any other interested party in real-time, facilitating timely intervention when necessary.

The present disclosure discloses a comprehensive system for monitoring and mitigating unsafe driving behavior through the integration of various sensors and analytical units within or attached to a vehicle. These sensors capture real-time data on vehicle performance, driver behavior (actions), and environmental conditions, which are then processed to identify unsafe driving attributes. The system detects driver behaviors such as speeding, lane deviations, or distracted driving based on predefined rules and algorithms. Upon detection, the system issues alert to the driver, recommending corrective actions to improve safety. If these measures are not implemented within a set time frame, the system may initiate preventive actions, such as speed reduction or emergency braking. Additionally, alerts may be sent to a guardian or relevant authority, enabling oversight and intervention when necessary. The system may interface with remote servers for faster analysis and coordination with law enforcement or emergency responders. Overall, the system aims to proactively address unsafe driving behaviors to enhance road safety for all road users.

The disclosed systems and methods provide a comprehensive solution for monitoring unsafe driving behaviors of drivers and taking proactive measures in response to unsafe driving behaviors. The methods and systems leverage advanced technologies such as artificial intelligence, machine learning, a network of capturing devices and a multi-tier approach for storing and processing unsafe driving behavior data, thereby providing a robust system to enhance road safety. The described system and methods would not be able to be accomplished with just human intelligence. The methods and systems focus on action-oriented approach, for example, proactive monitoring, immediate response, and effective communication and intervention to mitigate risks associated with unsafe driving behaviors in real-time.

The present disclosure focuses on monitoring and mitigating unsafe driving behavior for two-wheeled vehicles which is far more contextual and complex in nature than just mere individual features like speed warning, lane changes warning, or the like. The present disclosure considers real situations and scenarios to detect unsafe driving behavior such as speeding, sudden lane changes, and distracted driving. Upon detection of unsafe driving behavior, the driver is alerted in real-time and proactive measures are taken such as automatic speed reduction and/or emergency braking to prevent accidents. Interested parties or guardians are notified when necessary for timely intervention.

The action-oriented approach/solution proposed by the disclosure, where action taken by the system or by interested parties for review and penalties is tangible in nature and hence the solution proposed in the disclosure provides tangible output and is not an abstract idea.

Detecting unsafe driving behavior and taking proactive actions in response to unsafe driving behaviors in real-time such as automatic speed reduction and/or emergency braking are a technical solution to long standing problem. In prior art systems warning messages are the only action taken by the systems in question, and then sent only to the driver of the two-wheeled vehicle involved in dangerous driving activities. Detecting unsafe driving behavior and taking proactive actions in response to unsafe driving behaviors such as automatic speed reduction and/or emergency braking is not an abstract idea because it is not merely an idea itself (e.g., it cannot be performed mentally or using pen and paper). Detecting unsafe driving behavior and taking proactive actions in response to unsafe driving behaviors such as automatic speed reduction and/or emergency braking is not an abstract idea because it is not a fundamental economic practice (e.g., is not merely creating a contractual relationship, hedging, mitigating a settlement risk, etc.). Detecting unsafe driving behavior and taking proactive actions in response to unsafe driving behaviors such as automatic speed reduction and/or emergency braking is not an abstract idea as it is not a method of organizing human activity (e.g., managing a game of bingo). Detecting unsafe driving behavior and taking proactive actions in response to unsafe driving behaviors such as automatic speed reduction and/or emergency braking is not an abstract idea because the methods and systems are not simply a mathematical relationship/formula but instead include capturing real-time data using various sensors, analysing real-time driving activities, taking proactive measures/actions in response to detecting unsafe driving activity, and providing access to various interested third parties.

Detecting unsafe driving behavior and taking proactive actions in response to unsafe driving behaviors such as automatic speed reduction and/or emergency braking in real-time is not an abstract idea because it enhances road safety, prevents accidents, or reduces the number of accidents or unpredicted incidences, saves lives of users, and overall provides safe environment to road users.

Detecting unsafe driving behavior and taking proactive actions in response to unsafe driving behaviors such as automatic speed reduction and/or emergency braking in real-time is not an abstract idea because the disclosure requires one or more hardware components such as two-wheeled vehicles, cameras, sensors, memory, and software components such as a controller, user interface etc. The hardware and software components work in tandem with each other to enhance road safety.

Detecting unsafe driving behavior and taking proactive actions in response to unsafe driving behaviors such as automatic speed reduction and/or emergency braking in real-time are not an abstract idea because the disclosure allows for significant improvement to the technical fields of user experience on road, safety of road users, efficient processing, or the like.

The disclosure distinctly sets itself apart from the prior art by integrating one or more innovative features designed to enhance driver safety and improve overall road safety. Unlike existing systems that simply inform drivers about unsafe driving behaviors, the disclosure not only identifies such behaviors but also implements proactive measures to mitigate potential risks. The disclosure includes the detection of unsafe driving behaviors, such as excessive speeding, sudden lane changes, or aggressive acceleration. Upon recognizing these behaviors, the system takes immediate corrective actions, such as automatic speed reduction or emergency braking. This automatic intervention serves as a critical safety mechanism, reducing the likelihood of accidents and protecting not only the driver but also other road users. Additionally, this proactive approach addresses the limitations of traditional systems that rely solely on alerts and notifications. By directly intervening in dangerous situations, the system significantly enhances the driver's response time and overall driving experience. This dual-action capability—detecting unsafe behaviors and executing preventive measures—represents a substantial advancement in the field of driver behavior monitoring, providing a more comprehensive safety solution that prioritizes active risk management over passive notification and advances the art.

### Exemplary Environment

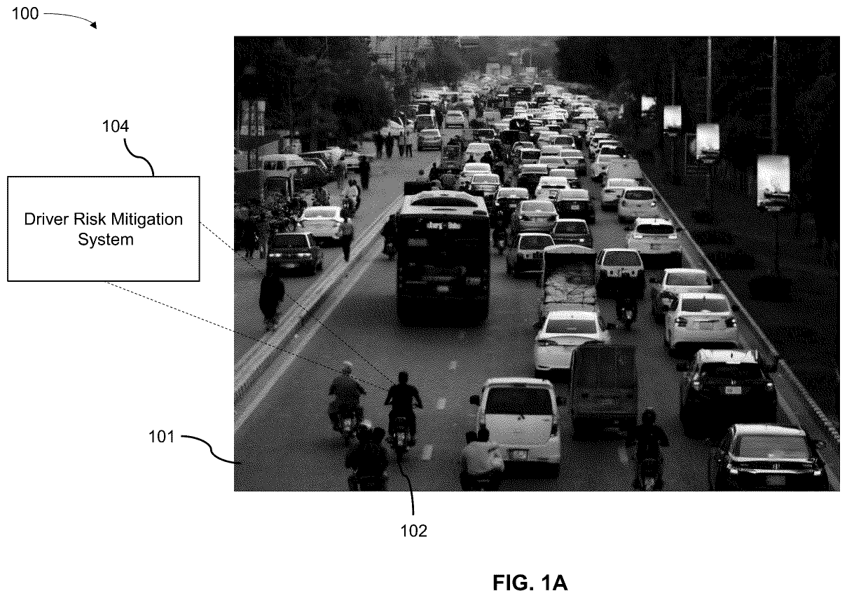

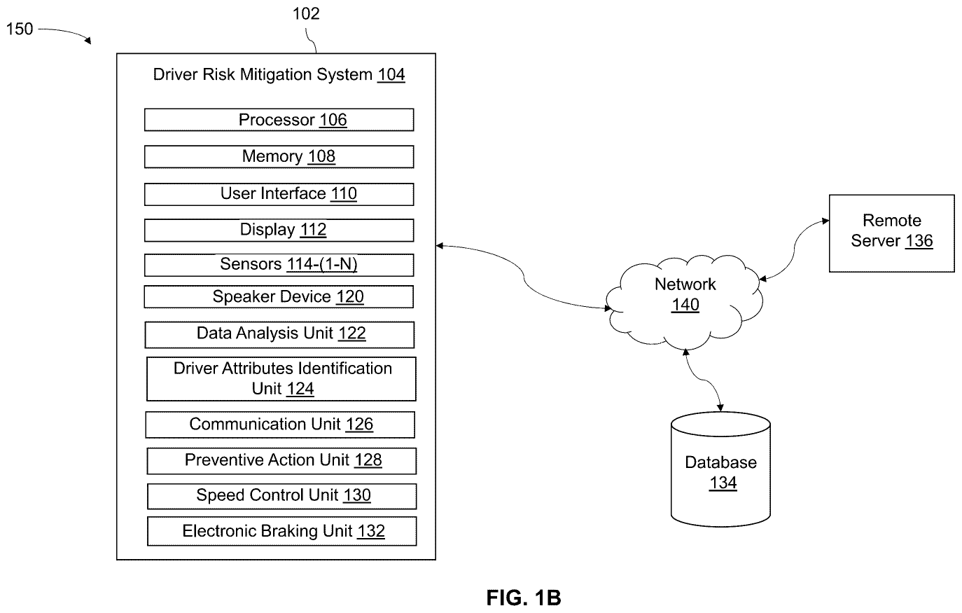

FIG. 1A illustrates an exemplary environment 100 in which various embodiments of the disclosure can be practiced. The environment 100 shows a road 101, where a plurality of vehicles including a two-wheeled vehicle 102 (interchangeably referred to as the vehicle 102) are running on the road 101. Examples of the vehicle 102 include, but are not limited to, a motorcycle and an electric scooter. The vehicle 102 may have at least one person, for example, a driver (operator) but may have more occupants such as passengers. Typically, the vehicle 102 is used for various purposes. For instance, the vehicle 102 may be utilized by a driver for commuting from home to the office or for recreational trips. Alternatively, the vehicle 102 may be used for daily household tasks or other types of work. In an example, the vehicle 102 is typically driven by a driver from point A to point B.

In examples, the driver of the vehicle 102 may exhibit different behaviors while on the road. At times, the driver may consistently adhere to traffic laws, respecting speed limits, traffic signals, and other regulations. Conversely, there may be instances where the driver consistently engages in unsafe practices, posing risks to other road users and the environment. These behaviors may include speeding, tailgating, unsafe lane changes, neglecting to wear protective gear such as helmet, or using distracting device (for example, mobile device or headphones) while driving. Additionally, there might be unpredictable patterns in the driver's behavior. For instance, the driver may alternate between cautious driving and reckless behavior, which can endanger both society and the environment.

In context of the current disclosure, the vehicle 102 includes a driver risk mitigation system 104. In an implementation, the driver risk mitigation system 104 of the vehicle 102 is capable of accurately monitoring behavior of the driver operating the vehicle 102, alerting the driver in case of unsafe driving behavior, and taking appropriate actions in real-time. The driver risk mitigation system 104 captures data related to vehicle performance, driver behavior, and environmental obstacles, which are then processed to identify unsafe driving attributes. The driver risk mitigation system 104 detects driver behaviors such as speeding, lane deviations, or distracted driving based on predefined rules and algorithms. Upon detection, the driver risk mitigation system 104 issues alert to the driver, recommending corrective actions to improve safety. If these measures are not implemented within a set time frame, the driver risk mitigation system 104 may initiate preventive actions, such as speed reduction or emergency braking. Additionally, alerts may be sent to a guardian or relevant authority, enabling oversight and intervention when necessary. This way, the disclosure enhances safety of the driver operating the vehicle 102 on the road 101 and prevents any accidents or losses of lives. The way the driver risk mitigation system 104 monitors the behavior of the driver operating the vehicle 102, alerts the driver in case of unsafe driving behavior, and takes appropriate actions, in described in greater detail in FIG. 1B.

### Exemplary System

FIG. 1B discloses an overall system, 150, for monitoring behavior of a driver operating a two-wheeled vehicle and implementing one or more preventive actions based on the behavior of the driver. The system 150 includes a two-wheeled vehicle 102, interchangeably referred to as the vehicle 102. The vehicle 102 may have at least one person, for example, a driver (operator) but may have more occupants such as passengers.

In examples, the driver of the vehicle 102 may exhibit different behaviors while on the road. At times, the driver may consistently adhere to traffic laws, respecting speed limits, traffic signals, and other regulations. Conversely, there may be instances where the driver consistently engages in unsafe practices, posing risks to other road users and the environment. These behaviors may include speeding, tailgating, unsafe lane changes, neglecting to wear protective gear such as helmet, or using distracting device (for example, mobile device or headphones) while driving. Additionally, there might be unpredictable patterns in the driver's behavior. For instance, the driver may alternate between cautious driving and reckless behavior, which can endanger both society and the environment.

The vehicle 102 includes a driver risk mitigation system 104 that can be installed inside the vehicle 102 and/or on the vehicle 102. The driver risk mitigation system 104 includes a processor 106 and a memory 108. The processor 106 may execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. The processor 106 may be or include a general-purpose microprocessor, as a specialized co-processor or another type of data processing apparatus. In some cases, the processor 106 may perform high level operation of the driver risk mitigation system 104. For example, the processor 106 may be configured to execute or interpret software, scripts, programs, functions, executables, or other instructions stored in the memory 108.

The memory 108 may include computer-readable storage media, for example, a volatile memory device, a non-volatile memory device, or both. The memory 108 may include one or more read-only memory devices, random-access memory devices, buffer memory devices, or a combination of these and other types of memory devices. In some instances, one or more components of the memory can be integrated or otherwise associated with another component of the driver risk mitigation system 104. The memory 108 may store instructions that are executable by the processor 106. For example, the instructions may include instructions for time-aligning signals using an interference buffer and a motion detection buffer, such as through one or more of the operations of the example processes as described in any of the figures of the disclosure. The driver risk mitigation system 104 may also include a user interface 110, such as a touch screen, a haptic sensor, a voice-based input unit, or any other appropriate user interface. The driver risk mitigation system 104 may further include a display 112, such as a screen, a monitor connected to the device in any manner, or any other appropriate display. In an example, the display 112 may be a heads-up display (HUD) unit.

The driver risk mitigation system 104 includes a plurality of capturing devices in the form of one or more sensors 114-(1-N), a speaker device 120, a data analysis unit 122, a driver attributes identification unit 124, a communication unit 126, a preventive action unit 128, a speed control unit 130, and an electronic braking unit 132. Some components of the driver risk mitigation system 104 may be present or incorporated inside the vehicle 102, such as the memory 108 and some sensors 114-(1-N), while others are incorporated on the outside of the vehicle 102, such as some sensors 114-(1-N) with image-capturing capabilities and the communication unit 126, without deviating from the scope of the disclosure. The components 114-132 are connected to each other via a conventional bus or a later-developed protocol. Furthermore, the components 114-132 communicate with each other to perform various functions outlined in the present disclosure.

The system 150 may further include a database 134, a remote server 136, and a network 140 enabling communication between the system components. The network 140 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the vehicle 102 (the driver risk mitigation system 104) and the remote location such as the database 134 and the remote server 136. Although it has been shown that the speed control unit 130, the electronic braking unit 132, and the database 134 are external to the driver risk mitigation system 104, in some implementations, the speed control unit 130, the electronic braking unit 132, and the database 134 may be implemented within the driver risk mitigation system 104.

The driver risk mitigation system 104 may further include additional component(s) as required to implement the present disclosure. As shown, the driver risk mitigation system 104 can be communicatively coupled to the database 134 and the remote server 136 via the network 140.

In an implementation, the data analysis unit 122, the driver attributes identification unit 124, the communication unit 126, the preventive action unit 128, the speed control unit 130, and the electronic braking unit 132 amongst other units, may include routines, programs, objects, components, data structures, etc., which may perform particular tasks or implement particular abstract data types. In examples, the data analysis unit 122, the driver attributes identification unit 124, the communication unit 126, the preventive action unit 128, the speed control unit 130, and the electronic braking unit 132 may also be implemented as signal processor(s), state machine(s), logic circuitries, and/or any other device or component that manipulate signals based on operational instructions. In some embodiments, the data analysis unit 122, the driver attributes identification unit 124, the communication unit 126, the preventive action unit 128, the speed control unit 130, and the electronic braking unit 132 may be implemented in hardware, instructions executed by a processing module, or by a combination thereof. In examples, the processing module may be the processor 106. The processing module may comprise a computer, a processor, a state machine, a logic array, or any other suitable devices capable of processing instructions. The processing module may be a general-purpose processor which executes instructions to cause the general-purpose processor to perform the required tasks or the processing module may be dedicated to performing the required functions. In some embodiments, the data analysis unit 122, the driver attributes identification unit 124, the communication unit 126, the preventive action unit 128, the speed control unit 130, and the electronic braking unit 132 may be machine-readable instructions which, when executed by a processor/processing module, perform intended functionalities of the data analysis unit 122, the driver attributes identification unit 124, the communication unit 126, the preventive action unit 128, the speed control unit 130, and the electronic braking unit 132. The machine-readable instructions may be stored on an electronic memory device, hard disk, optical disk, or other machine-readable storage medium or non-transitory medium. In an implementation, the machine-readable instructions may also be downloaded to the storage medium via a network connection.

The present disclosure offers peer-to-cloud communication and cloud-to-peer communication. In peer-to-cloud communication, the vehicle 102 may communicate with the database 134 and the remote server 136, via the network 140 for various purposes such as transmitting the captured data, analysing, and processing the captured data, storing the captured data, and other data relevant for implementing the disclosure. In cloud-to-peer communication, the remote server 136 may communicate with the vehicle 102 for various purposes such as receiving the processed data, receiving the incident of unsafe driving, receiving information about unsafe driving, and other data relevant for implementing the disclosure and recommendations.

The sensors 114-(1-N) (interchangeably referred to as capturing devices 114-(1-N)) are installed on the vehicle 102 for capturing vehicle-related data and driver-related data pertaining to the vehicle 102 and the driver of the two-wheeled vehicle 102, respectively in real-time. The captured data may comprise audio data, video data, or combination of both. Some non-limiting examples of the sensors 114-(1-N) may include one or more high-resolution imaging devices such as cameras, Charge-Coupled Device (CCD) imaging device, one or more infrared imaging devices, one or more gyroscopes, one or more Light Detection and Ranging (LiDAR) devices, one or more sonar devices, one or more radar devices, one or more thermal sensing devices, one or more audio capturing devices, one or more accelerometers, one or more global positioning system (GPS) device, and so on. These are few examples of the sensors 114-(1-N). Other known sensors or later developed sensors may be used to capture the vehicle-related data pertaining to the vehicle 102 and the driver-related data pertaining to the driver of the vehicle 102. According to an implementation, when the vehicle 102 is started, the sensors 114-(1-N) installed on/inside the vehicle 102 are automatically activated.

In examples, the high-resolution imaging device may capture images and videos of the driver, as well as images and videos of the vehicle 102 from various angles, including the sides, rear, and front. In an example, the high-resolution imaging device may capture images and videos of the driver and the vehicle throughout the journey. In an example, by using these images and videos, it can be determined whether the driver is wearing a helmet and/or whether the driver is using a mobile device, headphones, or earphones while driving. The infrared imaging devices may capture thermal images of desired portions of the interior compartments of the vehicle 102. The one or more gyroscopes may capture orientation and angular velocity of the vehicle 102. The LiDAR devices can detect various objects (referred to as obstacles in the context of the present disclosure) and accurately measuring the distance between the vehicle 102 and these objects. These objects include animals, pedestrians, road conditions, obstacles obstructing travel, other vehicles on the route, traffic signs, signals, pedestrian crossings, speed limit signs, as well as identifying hazardous conditions such as snow or water on the road. This detection is achieved through advanced laser technology, providing early indications to the driver of potential unsafe areas or objects ahead. The one or more sonar devices may detect an object using sound waves. In examples, data relating to the objects/obstacles captured by the sensors 114-(1-N) may be referred to as obstacle-related data. The radar devices may monitor the speed of the vehicle 102. The audio capturing devices may capture audio of the surroundings such as exterior sounds of the other vehicles. Additional examples of the capturing devices may include proximity sensors, thermal sensors, information control unit and others.

The combination of one or more sensors 114-(1-N) may capture or measure vehicle-related data related to the vehicle 102. In a non-limiting example, the vehicle-related data may include information pertaining to current speed, acceleration, direction, speed variations, location changes (such as lane changes), current location, and mapping of the roadway (including lane configurations) along the path of the vehicle 102. Further, the combination of the one or more sensors 114-(1-N) may capture or measure driver-related data related to the driver of the vehicle 102. In a non-limiting example, the driver-related data may include information pertaining to lane deviation frequency, failure to allow sufficient distance when changing lanes, tailgating, response time to traffic signals, frequency of aggressive maneuvers, adherence to traffic rules, level of attentiveness, engagement with distracting devices, and use of protective gear. Furthermore, the combination of the one or more sensors 114-(1-N) may capture or measure obstacle-related data. In a non-limiting example, the obstacle-related data may include information pertaining to one or more objects present on road, such as animals, pedestrians, road conditions, other vehicles on the route, traffic signs, signals, pedestrian crossings, speed limit signs, as well as identifying hazardous conditions such as snow or water on the road. The captured vehicle-related data, the driver-related data, and the obstacle-related data may be stored in the memory 108 for later retrieval, access, and/or use. In some implementations, the captured vehicle-related data, the driver-related data, and the obstacle-related data may be stored in the database 134 for later retrieval, access, and/or use. In an example, the captured vehicle-related data, the driver-related data, and the obstacle-related data may be stored in various formats. The data is stored such that it can be accessed by various parties, law enforcement authorities or any users who requests for the data.

In an implementation, the one or more sensors 114-(1-N) may capture the vehicle-related data, the driver-related data, and the obstacle-related data from a single driving session. In some implementations, the one or more sensors 114-(1-N) may capture the vehicle-related data, the driver-related data, and the obstacle-related data from multiple driving sessions. For example, a single driving session may refer to a single instance of the driver operating the vehicle 102, which could range from a short commute to a longer journey. Multiple driving sessions refer to several instances of driving over a period of time.

According to an implementation, the sensors 114-(1-N) may send the captured vehicle-related data, the driver-related data, and the obstacle-related data to both the data analysis unit 122 and the driver attributes identification unit 124 for further analysis and/or processing. The data analysis unit 122 analyses the captured vehicle-related data to identify the commencement of a trip by the driver of the vehicle 102. Various algorithms may be employed to automatically detect the start of a trip by the driver of the vehicle 102. In an implementation, the data analysis unit 122 may process the captured vehicle-related data in real-time using artificial intelligence and/or machine learning algorithms to identify the commencement of a trip by the driver of the vehicle 102.

As an example, the data analysis unit 122 may obtain information pertaining to the current speed of the vehicle 102 from the vehicle-related data. The current speed can be obtained from data indicating the acceleration of the vehicle 102, gathered by the accelerometer equipped on the vehicle 102. Alternatively, or additionally, the data analysis unit 122 may obtain the current speed of the vehicle 102 by receiving coordinates from a GPS device equipped on the vehicle 102 and calculating the speed from these coordinates. The data analysis unit 122 then evaluates whether the current speed of the vehicle 102 exceeds (or is equal to) a predetermined threshold. The predetermined threshold may vary for different vehicles and can be adjustable. For example, the predetermined threshold may be set within a range from 5 to 15 miles per hour, or from 8 to 12 miles per hour. In certain cases, the predetermined threshold may be set, for instance, at 10 miles per hour, so that the trip commencement is identified when the current speed exceeds 10 miles per hour. If the current speed exceeds the predetermined threshold, it indicates that the trip has begun by the driver of the vehicle 102. Other methods for detecting the commencement of the trip by the driver of the vehicle 102 are contemplated herein.

According to an implementation, upon detection of the commencement of the trip by the driver of the vehicle 102, the driver attributes identification unit 124 may process the driver-related data and the obstacle-related data to identify one or more driver attributes associated with unsafe driving behavior of the driver, based on one or more predefined rules. The driver attributes identification unit 124 may use artificial intelligence and/or machine learning algorithms to identify the one or more driver attributes associated with unsafe driving behavior. For example, the driver attributes identification unit 124 may identify the one or more driver attributes associated with unsafe driving behavior based on one or more predefined rules and algorithms. Examples of unsafe driving behavior may include, but are not limited to, speeding at significantly high speeds well above the legal speed limits (i.e., exceeding speed limits), frequent lane changes without appropriate signaling, lane changes without allowing sufficient distance between the vehicles, lane filtering in inappropriate situations or conditions, tailgating other vehicles, exhibiting road rage, running through traffic stops and traffic lights, neglecting to wear protective gear (such as a helmet), driving the vehicle on a street or pathway where that type of vehicle is not allowed, driving the vehicle at hours not allowed by local or state regulations, driving the vehicle in an area that was forbidden by a parent or guardian, and using distracting devices (such as mobile phones, headphones, and earphones) while driving. In some implementations, any activities or driving behaviors that are inherently dangerous, harmful to society, or violate the law are considered unsafe driving behaviors.

The rules and algorithms utilized by the artificial intelligence or machine learnings systems can be activity-based, time-based, frequency-based, type of activities, or a combination thereof. In example, the predefined rules may be based on historical data, local traffic laws, safety regulations, and any instructions or recommendations regarding safe driving provided by the guardian of the driver. For example, the speed of the vehicle 102 may be compared with the speed limits specified for the road. In an example, a rule may state that if the vehicle speed exceeds a certain threshold above the legal limit (for example, 15 miles per hour over the limit) for more than 5 minutes, then the behavior of the driver may be identified as unsafe. Similarly, if the driver changes lanes more than 3 times within a 5-minute window without signaling, the behavior of the driver may be identified as unsafe. Additionally, if the total duration of honking exceeds 30 seconds within a 10-minute time frame, the behavior of the driver may be identified as unsafe. Also, if is detected that the driver is using a mobile device or earphones for more than 5 consecutive minutes while the vehicle 102 is in motion, the behavior of the driver may be identified as unsafe. Furthermore, if it is detected that the driver of the vehicle 102 is not wearing a helmet for more than 2 continuous minutes after the commencement of the trip, the behavior of the driver may be determined as unsafe. According to an implementation, the driver attributes identification unit 124 may store the identified one or more driver attributes associated with unsafe driving behavior of the driver in the memory 108 and/or database 134 for later retrieval, access, and/or use.

In some implementations, the data analysis unit 122 and the driver attributes identification unit 124 may analyse the vehicle-related data, the driver-related data, and the obstacle-related data based on an input received from the driver and/or a guardian of the driver. For example, the analysis of the vehicle-related data, the driver-related data, and the obstacle-related data may be performed at pre-selected times (for example, weekly, daily, or monthly) according to the preferences or needs of the driver and/or the guardian. In an implementation, the driver risk mitigation system 104 may employ one or more encryption protocols to encrypt the vehicle-related data, the driver-related data, and/or the obstacle-related data to ensure the privacy and integrity of the information. Encryption converts data into a coded format that can only be decrypted by authorized users, thereby safeguarding it from potential threats. This security feature is particularly important in scenarios where a minor is operating the two-wheeled vehicle 102. In cases, the minor driver may realize that he or she is not operating the vehicle 102 safely and may attempt to erase or modify the data sent to the cloud (such as the remote server 136) or stored locally (such as the memory 108).

To prevent unauthorized access or tampering with the vehicle-related data, the driver-related data, and/or the obstacle-related data, the driver risk mitigation system 104 is designed in a way that restricts the vehicle driver from altering or deleting the recorded data (i.e., the vehicle-related data, the driver-related data, and/or the obstacle-related data). This means that even if the driver attempts to access the driver risk mitigation system 104 to modify driving history, the data remains protected and unaltered, thereby ensuring its reliability. This protective measure not only promotes accountability among young drivers but also enhances overall safety by ensuring that any concerning behavior is accurately documented and available for review by guardians and/or interested parties.

The availability of unaltered data has significant implications for guardian and/or interested party who are responsible for overseeing the safety of young drivers. By having access to accurate driving data, the guardian and/or any interested party are enabled to identify patterns of unsafe driving behavior early on, facilitating timely interventions. For instance, if the data indicates a recurring issue with speeding or aggressive driving, guardians and/or any interested party can take proactive measures to address these behaviors, such as enrolling the driver child in a driver safety course or having open conversations about the risks associated with unsafe driving.

According to an implementation, upon identifying the one or more driver attributes associated with unsafe driving behavior, such as speeding, not wearing a helmet, or using earphones, the communication unit 126 may send an alert to the driver, notifying the driver of his/her unsafe driving behavior. In examples, the alert may act as an immediate feedback measure to encourage safer driving practices. In examples, the alert may include recommendations for one or more corrective measures for the driver to be implemented. In a non-limiting example, the one or more corrective measures include reducing the speed of the vehicle 102, ensuring the wearing of a protective gear, discontinuing the use of distracting devices, stopping the vehicle 102, restarting the vehicle 102, changing gears in case of hazardous conditions such as snow or water on the road, and providing instructions to the driver on navigating around a particular obstacle. For example, if the driver is speeding, the communication unit 126 may send an alert to reduce the vehicle speed to within the legal limit or to a safer limit. In another scenario, if the driver is not wearing protective gear, such as a helmet, the communication unit 126 may send an alert instructing the driver to put on the helmet immediately. Similarly, if the driver is using distracting devices, such as earphones or a mobile device, the communication unit 126 may send an alert to the driver to discontinue device usage.

In some examples, the alert may further include a notification indicating that one or more preventive actions will be initiated if the driver does not implement the one or more corrective measures. For example, if the driver is speeding, the communication unit 126 may send an alert to reduce the vehicle speed to within the legal limit or to a safer limit. The communication unit 126 may send a further alert to the driver notifying that if the driver does not reduce the speed, then emergency braking will automatically get activated.

In examples, the one or more preventive actions may include at least one of initiating a stopping procedure of the vehicle 102, changing gears of the vehicle 102, activating automatic emergency braking, adjusting speed of the vehicle 102, disabling one or more vehicle functionalities until the one or more corrective measures are implemented, and notifying law enforcement authorities and/or a guardian or interested party of the driver. In additional examples, the one or more preventive actions may include the full disablement of the vehicle 102.

In an implementation, the preventive action unit 128 may ascertain, after a preset time duration has elapsed, whether the driver has implemented the one or more corrective measures. Upon ascertaining that the driver has not implemented the one or more corrective measures, the preventive action unit 128 may execute the one or more preventive actions. In an example, the preset time interval may be 1 minute. Taking a scenario for example, after the driver engages in a behavior that triggers the driver risk mitigation system 102, such as exceeding the speed limit, the driver risk mitigation system 102 may activate a timer (not shown in FIG. 1) for 1 minute. If the driver successfully implements the corrective measure within the 1-minute time interval, no further action is taken by the driver risk mitigation system 102. However, if the driver fails to implement the corrective measure within the preset time interval (i.e., 1 minute in this example), the preventive action unit 128 may execute one or more preventive actions, such as activating emergency braking. In an implementation, the preventive action unit 128 is configured to employ one of an artificial intelligence (AI) model and a machine learning (ML) model for executing the one or more preventive actions if the one or more corrective measures are not implemented by the driver within the pre-determined time period.

According to some implementations, the alert may include recommendations for one or more corrective measures for the driver to be implemented within a pre-determined time period. The one or more corrective measures may vary depending on the nature of the unsafe behavior detected. Furthermore, the alert may also include a notification indicating that one or more preventive actions will be initiated if the one or more corrective measures are not implemented by the driver within the pre-determined time period. The notification acts as an additional safety measure to mitigate potential risks associated with continued unsafe behavior. In examples, failure to implement the corrective measures within the pre-determined time period may trigger the execution of preventive actions to mitigate potential risks and ensure the safety of the driver and other road users.

In examples, the alert can be in the form of text, audio message, video, or a combination thereof. The alert that is in the form of text may be referred to as text alert, the alert that is in the form of audio message may be referred to as voice alert or audible alert, and the alert that is in the form of video or image may be referred to as visual alert. In an implementation, the communication unit 126 may send a text alert on the display 112 (for example, heads-up display unit) of the vehicle 102. In an example, the text alert may be a message “Attention: For safe riding, wearing your helmet is essential. Please ensure you put on the helmet within the next 2 minutes. Failure to comply will prompt the activation of automatic emergency braking.” This message effectively emphasizes the critical need to wear the helmet and emphasize on the urgency of the situation by specifying a time limit. In an implementation, the communication unit 126 may send an audible alert to the driver through the speaker device 120 of the vehicle 102, providing spoken messages or instructions to the driver. The audible alert may be a spoken message “Warning—Using your phone while driving is dangerous. You have 20 seconds to stop phone usage. Failure to comply will result in automatic vehicle halt.” In examples, the spoken message may be a recorded message in human voice (for example, guardian) or may be system generated. These alerts may be facilitated by prestored data listing the alerts or generated by artificial intelligence/machine language systems.

In an implementation, the communication unit 126 may display a visual alert on the display 112 of the vehicle 102. In an example, a visual alert may be an image or a video clip demonstrating the trajectory of the vehicle 102 relative to lane markings, prompting the driver to take corrective action to steer the vehicle 102 back into the lane safely immediately. The video clip may also include a message instructing the driver to do so within 10 seconds. This visual alert effectively communicates the potential danger of drifting out of the lane, providing visual reinforcement and guidance to the driver of the vehicle 102 to prevent a potential collision or accident. According to some implementations, the communication unit 126 may send the alert to a personal device of the driver, such as a mobile device, a tablet phone, a laptop, or a desktop computer.

According to an implementation, the preventive action unit 128 may execute the one or more preventive actions if the one or more corrective measures are not implemented by the driver within the pre-determined time period. As described above, the one or more preventive actions may include at least one of initiating a stopping procedure of the vehicle 102, changing gears of the vehicle 102, activating automatic emergency braking, adjusting speed of the vehicle 102, disabling one or more vehicle functionalities until the one or more corrective measures are implemented, and notifying law enforcement authorities and/or a guardian of the driver. For example, if the driver fails to reduce the vehicle speed after receiving the initial alert, the preventive action unit 128 may automatically reduce the speed of the vehicle 102. In some examples, the preventive action unit 128 may initiate a stopping procedure for the vehicle 102 if the driver fails to respond to the alert and corrective measures. The stopping procedure may involve gradually bringing the vehicle 102 to a halt in a controlled manner. The implementation employs a proactive strategy to address unsafe driving behavior through timely alerts and actionable recommendations provided to the driver, thereby enhancing road safety for all road users including the driver. Through the execution of these preventive actions, the driver risk mitigation system 104 effectively intervenes in instances of persistent unsafe driving behavior, even after initial alerts and corrective measures. This proactive strategy enhances road safety by mitigating potential hazards before they escalate into accidents or incidents.

According to some implementations, the communication unit 126 may transmit a notification to both the speed control unit 130 and the electronic braking unit 132 upon detecting unsafe driving behavior of the driver. Examples of such behavior include, but not limited to, frequent lane changes, lane changes not allowing sufficient distance between the vehicles, exceeding speed limits, tailgating, neglecting to wear protective gear, and engaging with distracting devices during the trip. In response to receiving the notification, the speed control unit 130 may adjust the speed of the vehicle 102 or initiate a restart the vehicle 102. Similarly in some cases, the electronic braking unit 130 may activate brakes of the vehicle 102 and bring the vehicle 102 to a stop.

According to an implementation, upon ascertaining that the driver has not implemented the one or more corrective measures, the communication unit 126 may send an alert to a guardian of the driver to notify the guardian about unsafe driving behavior of the driver. In examples, the alert may be a customized alert. In an example, the customized alert may include dynamic elements that may be populated by the driver risk mitigation system 104. An example of a dynamic element is a field in which the guardian's name or the driver's name may be inserted. The communication unit 126 may also send the report to the insurance companies, particularly in instances where the vehicle 102 is leased to the driver, or regulatory agencies. The communication unit 126 may also send the report to a company leasing the vehicle 102 to the user. In an example, the alert includes a comprehensive analysis report covering various driver attributes associated with unsafe driving behavior. The report can be compiled daily, monthly, or on weekly basis, providing insights into driving patterns and areas for improvement. By providing the alert, the guardian can stay informed about the driver's driving habits and take appropriate action, such as initiating a conversation about safe driving practices or imposing consequences including suspending use of the vehicle 102. In examples, the alert may be sent or communicated via multiple channels, including a phone call, a text message, or an email.

According to one implementation, the guardian can customize the types of alerts the guardian receive based on specific parameters or thresholds. For instance, the guardian may opt to receive alerts only for certain types of unsafe behavior, such as exceeding a particular speed limit or neglecting to wear a helmet. Customizable alerts enable the guardian to focus on the most relevant aspects of the driver's behavior and address areas of concern more effectively.

In some implementations, the driver risk mitigation system 104 may integrate with a dedicated mobile application, allowing the guardian to receive alerts directly within the application interface. Furthermore, in-app notifications can provide additional context and features, such as access to historical driving data, trend analysis, and educational resources on safe driving practices. By centralizing all information within the mobile application, the guardian can easily monitor the driver's behavior and track improvements over time. In some implementations, the driver risk mitigation system 104 may generate periodic email reports summarizing the driver's behavior over a certain period, such as daily, weekly, or monthly. These reports can include aggregated data on various driving metrics, trends, and patterns, enabling the guardian to gain insights into the driver's overall habits. Email reports provide a convenient way for the guardian to review the driver's performance and identify areas for improvement or intervention. By employing these methods to send alerts to the guardian, the driver risk mitigation system 104 facilitates parental oversight or oversight to any other interested party, and involvement in the driver's experience, fostering a collaborative approach to promoting safe driving habits. Additionally, in certain implementations, the preventive action unit 128 may execute one or more preventive actions based on input received from the guardian or interested party of the driver.

According to an implementation, upon acquiring the vehicle 102 (i.e., purchasing the vehicle), the parent or guardian of the driver of the vehicle 102 may configure various parameters for receiving alerts regarding the driver's driving behavior. For example, the guardian may choose how often they wish to receive notifications, whether immediately upon detection of unsafe behavior, at the end of each trip, or on a daily or weekly summary basis. This flexibility allows the guardian to monitor driving behavior without being overwhelmed by constant notifications. Additionally, the driver risk mitigation system 104 may provide multiple options for alerting guardians. For example, the guardian can select from various communication methods, including text messages, phone calls, or both, ensuring that they receive alerts in a manner that suits their preferences and availability. The guardian can also specify which particular behaviors they wish to be alerted about, such as speeding, non-helmet use, harsh braking, or aggressive acceleration. This targeted approach allows the guardian to focus on the most critical aspects of driving behavior that concern them.

In an embodiment, the guardian may be enabled to remotely disable the vehicle 102 if necessary. In an implementation, the driver risk mitigation system 104 may provide an option to the guardian to remotely disable the vehicle 102, thereby allowing the guardian to prevent operation of the vehicle 102 in response to detected unsafe driving behavior or unauthorized use (i.e., causing full disablement of the vehicle 102). This feature serves as an essential safety mechanism, allowing the guardian to take immediate action in situations where they believe the vehicle 102 should not be operated. For example, if the guardian receives an alert indicating dangerous driving behavior or detects that the minor is operating the vehicle 102 under unsafe conditions, the guardian can remotely disable the vehicle 102, preventing further operation until the situation is addressed.

According to some implementations, the communication unit 126 may transmit the captured vehicle-related data, the driver-related data, and the obstacle-related data pertaining to the two-wheeled vehicle and the driver of the two-wheeled vehicle, respectively, to the remote server 136 for faster analysis, processing, use, and/or storage. The remote server 136 may be operated by law enforcement agencies, emergency responders, or fleet management companies. Although, a single remote server 136 is shown in FIG. 1B, the system 150 may include multiple remote servers. The multiple remote servers may perform the same functionality or may perform entirely different functionalities.

In an implementation, the remote server 136 may analyze the captured vehicle-related data, the driver-related data, and the obstacle-related data to identify one or more driver attributes associated with unsafe driving behavior and transmit the identified one or more driver attributes associated with unsafe driving behavior to the driver risk mitigation system 104. In some implementations, the remote server 136 may directly send an alert comprising recommendations for one or more corrective measures for the driver of the vehicle 102 to implement. The remote server 136 further sends an alert to a guardian of the driver, notifying the guardian about unsafe driving behavior of the driver.

Although the present disclosure primarily focuses on behavior monitoring and intervention for the operator (driver) of the vehicle 102, in some embodiments, the present disclosure may also be relevant to passenger(s) of the vehicle 102.

The described system 150 offers several advantages in promoting road safety and mitigating unsafe driving behaviors. The system 150 leverages real-time data analysis to promptly identify and address risky driving activities, helping to prevent accidents before they occur. Continuous monitoring of vehicle performance, driver behavior, and environmental factors allows the system 150 to identify various unsafe driving behaviors including speeding, lane deviations, and distracted driving. This comprehensive monitoring capability enables timely intervention, providing drivers with immediate alerts and recommendations for corrective action. Furthermore, the system 150 may be configured to customize alerts and integrate with mobile applications, thereby enabling personalized oversight, empowering guardians, or authorities to adapt their responses to specific driving behaviors or circumstances. Additionally, the implementation of preventive actions, such as speed reduction or emergency braking, provides an additional layer of safety by intervening when drivers do not respond to initial alerts. Furthermore, the integration of the system 150 with the remote server 136 enhances its effectiveness, allowing for quicker analysis and coordination with law enforcement authorities or emergency responders. This enables a prompt and synchronized reaction to potential safety threats. Overall, by promoting awareness, providing timely feedback, and enabling proactive intervention, the system 150 significantly enhances road safety and reduces the risk of accidents caused by unsafe driving behaviors.

The prior art systems primarily focus on issuing warnings or alerts to drivers when unsafe behaviors are detected, such as speeding, lane departures, or other violations of traffic laws. These systems often rely on simple threshold-based alerts, where drivers are notified after the fact without the capability to understand the context or adapt to driving conditions. For example, an alert may notify a driver that he or she is exceeding the speed limit, but it lacks the ability to provide context-specific advice or take further action if the driver does not comply. Additionally, according to the prior art systems, drivers receive alerts after engaging in unsafe behavior, and no real-time intervention occurs. For instance, prior art systems lack the ability to enforce compliance or automatically mitigate unsafe driving behaviors. If a driver ignores an alert, these systems do not provide any follow-up actions to prevent potential accidents.

In contrast, the driver risk mitigation system 104 offers a comprehensive approach that fundamentally improves upon traditional alert systems through several innovative features. For instance, the driver risk mitigation system 104 continuously analyzes the vehicle-related data, the driver-related data, and the obstacle-related data in real-time, allowing for immediate detection of unsafe behaviors and context-aware responses. This data-driven approach enables the driver risk mitigation system 104 to evaluate whether the driver's behavior is indeed unsafe based on historical patterns and current conditions. Additionally, instead of generating generic alerts, the driver risk mitigation system 104 generates tailored messages that consider the specific driving situation. For example, if a driver is speeding in a school zone, the alert can emphasize the increased risk and suggest immediate corrective actions, such as reducing speed to a safe limit. A major advancement of the driver risk mitigation system 104 is its capability to initiate preventive measures automatically. For instance, if a driver fails to respond to an alert, the driver risk mitigation system 104 can take actions such as adjusting the vehicle's speed, activating emergency braking, disabling certain functionalities of the vehicle 102, or fully disabling the vehicle 102. This proactive approach ensures that unsafe behaviors are not only identified but actively mitigated, significantly reducing the likelihood of accidents.

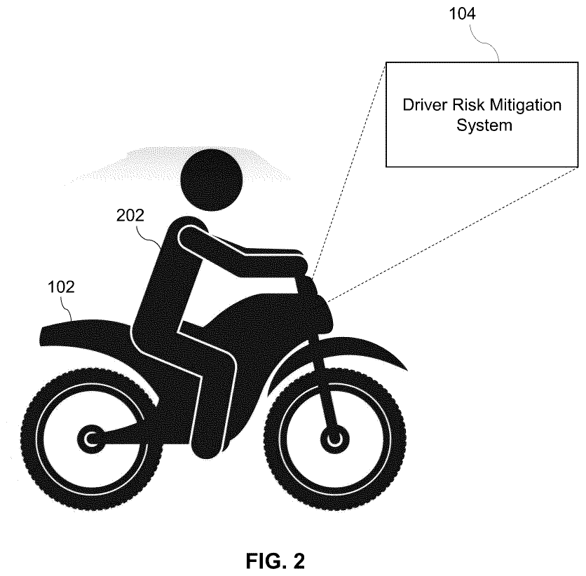

FIG. 2 depicts a visual representation of a driver 202 operating the vehicle 102 (for example, a motorcycle) without adhering to safety measures such as wearing a helmet. Failure to wear the helmet poses significant risks to the safety of both the driver 202 and other road users. The vehicle 102 includes the driver risk mitigation system 104, as shown in FIG. 2 on the front side of the vehicle 102. The driver risk mitigation system 104 actively monitors the driver's behavior and addresses potential risks or hazards. While the driver risk mitigation system 104 is shown to be situated/installed on the front side of the vehicle 102, its installation is not limited to this location. Depending on several factors such as vehicle design or user preferences, the driver risk mitigation system 104 can be installed at alternative locations on the vehicle 102 for enhanced safety.

According to an implementation, the driver risk mitigation system 104 captures vehicle-related data, driver-related data, and obstacles-related data pertaining to the vehicle 102, the driver 202 operating the vehicle 102, and obstacles surrounding the vehicle 102, respectively. The driver risk mitigation system 104 analyzes the captured vehicle-related data, the driver-related data, and the obstacle-related data to identify at least one driver attribute associated with unsafe driving behavior, based on one or more predefined rules. In the given example, the driver attribute associated with unsafe driving behavior includes neglecting to wear protective gear (i.e., the helmet). Upon the identification of the driver attributes, the driver risk mitigation system 104 may send an alert to the driver 202. The alert may include recommendations for one or more corrective measures for the driver 202 to be implemented within a pre-determined time period. The alert further includes a notification indicating that one or more preventive actions will be initiated if the driver does not implement the one or more corrective measures 202 within the pre-determined time period.

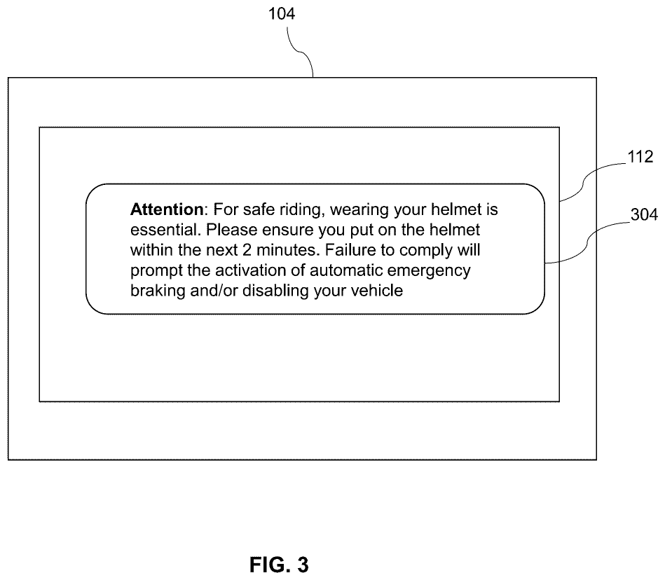

FIG. 3 is a continuation of FIG. 2. FIG. 3 shows an example of an alert 304 displayed to the driver 202 of the vehicle 102 in response to detecting that the driver 202 is not wearing a helmet while operating the vehicle 102. The driver risk mitigation system 104 sends a text alert 304 on the display 112 of the vehicle 102. In an example, the text alert 304 may be a message “Attention: For safe riding, wearing your helmet is essential. Please ensure you put on the helmet within the next 2 minutes. Failure to comply will prompt the activation of automatic emergency braking and/or disabling your vehicle.” This message effectively emphasizes the critical need to wear the helmet and emphasize on the urgency of the situation by specifying a time limit.

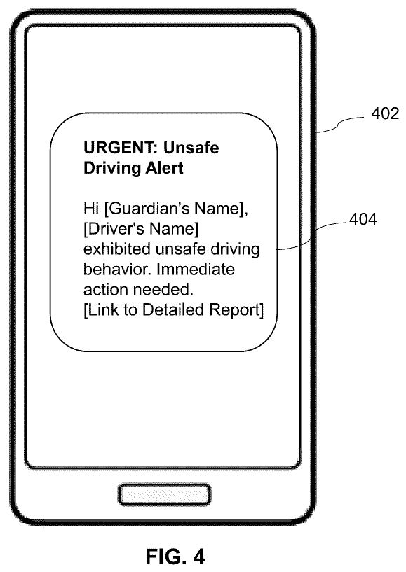

FIG. 4 illustrates a text message displayed on a mobile device of a guardian of a driver or other interested party responsive to ascertaining that the driver has not implemented the one or more corrective measures. Ref. ring to FIG. 4, when the driver has not implemented the one or more corrective measures, a text message 404 may be displayed to the guardian of the driver on the mobile device 402 of the guardian. As can be seen in FIG. 4, text message 404 reads “Hi [Guardian's Name], [Driver's Name] exhibited unsafe driving behavior. Immediate action needed.” The text message 404 includes dynamic fields, such as guardian's name and the driver's name. The text message 404 further includes a link to the detailed report of the driver.

### Exemplary Method Flowchart

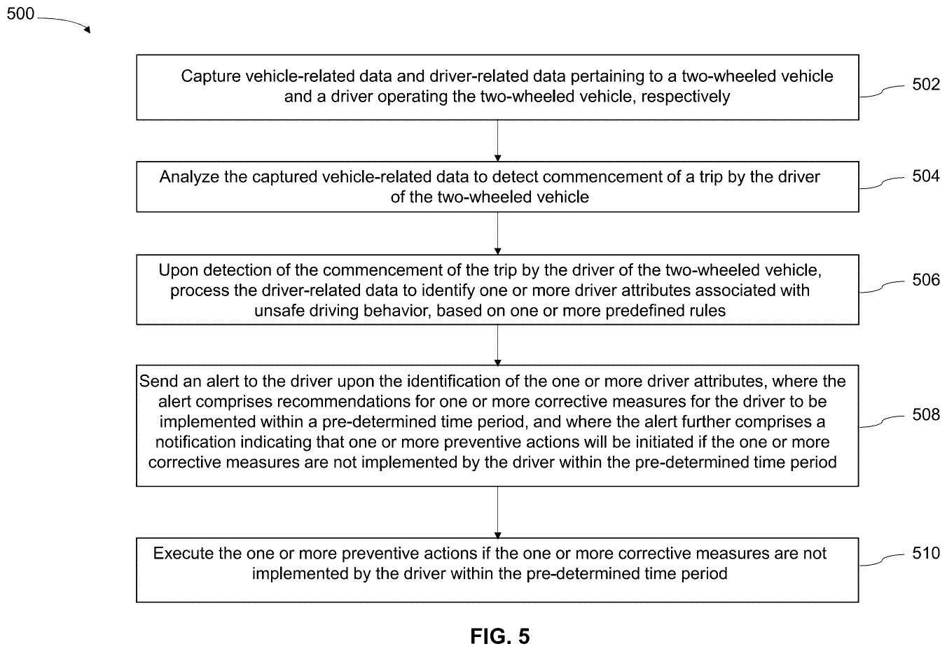

FIG. 5 is a method flowchart 500 for monitoring behavior of a driver operating a two-wheeled vehicle and implementing preventive actions for the driver. The method 500 can be implemented by any vehicle incorporating the driver risk mitigation system 104. The driver risk mitigation system 104 is automatically activated when a vehicle (for example, the vehicle 102) is started. Specifically, the method 500 automatically activates various components of the driver risk mitigation system 104 such as the display 112, the plurality of sensors 114-(1-N), the data analysis unit 122, the driver attributes identification unit 124, the communication unit 126, the preventive action unit 128 etc., as discussed above. The method 500 is described with respect to the system 150 comprising the vehicle 102.

The method 500 is performed when the vehicle 102 is started and upon starting the vehicle 102, the plurality of sensors installed on/inside the vehicle 102 are automatically activated. Some examples of plurality of capturing devices include but are not limited to one or more of a high-resolution imaging device, an infrared imaging device, a gyroscope, a LiDAR device, a sonar device, a radar device, a GPS device, an accelerometer, and an audio capturing device.

At step 502 of the method 500, vehicle-related data and driver-related data pertaining to a two-wheeled vehicle and a driver of the two-wheeled vehicle, respectively, are captured. According to an implementation, the plurality of capturing devices 114-(1-N) equipped on the two-wheeled vehicle 102 may be configured to capture the vehicle-related data and the driver-related data. In examples, the plurality of capturing devices 114-(1-N) includes one or more of a high-resolution imaging device, an infrared imaging device, a gyroscope, a LiDAR device, a sonar device, a radar device, a GPS device, an accelerometer, and an audio capturing device. In a non-limiting example, the vehicle-related data may include information pertaining to current speed, acceleration, direction, speed variations, location changes, current location, and mapping of a roadway along a path of the two-wheeled vehicle 102. In another non-limiting example, the driver-related data may include information pertaining to lane deviation frequency, response time to traffic signals, adherence to traffic rules, level of attentiveness, engagement with distracting devices, and use of protective gear. In examples, the protective gear may be a helmet, and the distracting devices may include earphones, headphones, and/or mobile devices.

At step 504 of the method 500, the captured vehicle-related data is analyzed to detect commencement of a trip by the driver of the two-wheeled vehicle. According to an implementation, the data analysis unit 122 may be configured to analyze the captured vehicle-related data to detect commencement of a trip by the driver of the two-wheeled vehicle 102.

At step 506 of the method 500, upon detection of the commencement of the trip by the driver of the two-wheeled vehicle, the driver-related data is processed to identify one or more driver attributes associated with unsafe driving behavior, based on one or more predefined rules. According to an implementation, the driver attributes identification unit 124 may be configured to processing the driver-related data to identify one or more driver attributes associated with unsafe driving behavior, based on one or more predefined rules, upon detection of the commencement of the trip by the driver of the two-wheeled vehicle 102. In examples, the one or more driver attributes associated with unsafe driving behavior includes at least one of frequent lane changes, lane changes not allowing sufficient distance between the vehicles, exceeding speed limits, tailgating, neglecting to wear protective gear, and engaging with distracting devices during the trip.

At step 508 of the method 500, an alert is sent to the driver upon the identification of the one or more driver attributes, where the alert comprises recommendations for one or more corrective measures for the driver to be implemented within a pre-determined time period, and where the alert further comprises a notification indicating that one or more preventive actions will be initiated if the one or more corrective measures are not implemented by the driver within the pre-determined time period. According to an implementation, the communication unit 126 may be configured to sending the alert to the driver upon the identification of the one or more driver attributes. In an example, the one or more corrective measures may include reducing the speed of the two-wheeled vehicle, ensuring the wearing of a protective gear, and discontinuing the use of distracting devices.

At step 510 of the method 500, the one or more preventive actions are executed if the one or more corrective measures are not implemented by the driver within the pre-determined time period. In examples, the one or more preventive actions may be executed based on employing one of an artificial intelligence (AI) model and a machine learning (ML) model. According to an implementation, the preventive action unit 128 may be configured to execute the one or more preventive actions if the one or more corrective measures are not implemented by the driver within the pre-determined time period. In examples, the one or more preventive actions includes at least one of initiating a stopping procedure of the two-wheeled vehicle, changing gears of the two-wheeled vehicle, activating automatic emergency braking, adjusting speed of the two-wheeled vehicle, disabling one or more vehicle functionalities until the one or more corrective measures are implemented, and notifying law enforcement authorities and/or a guardian or interested party of the driver.

In one implementation, the method 500 uses artificial intelligence and/or machine learning to analyze the captured data, processing the captured data to identify one or more driver attributes associated with unsafe driving behavior, sending alerts to the driver, where the alert comprises recommendations for one or more corrective measures for the driver, and executing the one or more preventive actions if the one or more corrective measures are not implemented by the driver.

The methods and systems focus on real-time monitoring, real-time analysis, and identification of one or more driver attributes associated with unsafe driving behavior, real-time warning or sending alerts comprising recommendations for one or more corrective measures for the driver to be implemented, and real-time execution of the one or more preventive actions.

The methods and systems can incorporate the use of artificial intelligence and machine learning to identify one or more driver attributes associated with unsafe driving behavior in real-time. For example, artificial intelligence and machine learning techniques are configured for measuring the speed, time, date, acceleration, direction, speed variations, location, and mapping of the roadway relating to the offending vehicle. The method and systems further incorporate image recognition technologies such that it can identify the vehicle, license plate, various characteristics of the vehicle such as, and not limited to, color, model, type of vehicle, and its manufacturer. Machine language and Artificial Intelligence processing may also be utilized to formulate the messages that are being sent to vehicles along with law enforcement agencies.

The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

The foregoing is illustrative only and is not intended to be in any way limiting. Reference is made to the accompanying drawings, which for a part hereof. In the drawings, similar symbols typically identify similar components, unless context dictates otherwise.

Note that the functional blocks, methods, devices, and systems described in the present disclosure may be integrated or divided into different combinations of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement distinct functions described herein. For example, the present application may be implemented using a general purpose or dedicated processor running a software application through volatile or non-volatile memory. Also, the hardware objects could communicate using electrical signals, with states of the signals representing different data.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented driver risk mitigation method for two-wheeled vehicles, the method-comprising:
receiving, using a processor operating in communication with a plurality of sensors, vehicle-related data and driver-related data pertaining to a two-wheeled vehicle and a driver operating the two-wheeled vehicle, respectively;
analysing, using the processor, the received vehicle-related data to detect commencement of a trip by the driver of the two-wheeled vehicle;
processing, using the processor, the driver-related data to identify at least one driver attribute associated with an unsafe driving behavior based on at least one predefined rule;
sending, using the processor, an alert to an output device for the driver upon the identification of the at least one driver attribute, wherein the alert comprises at least one recommendation for one or more corrective measures for the driver to be implemented within a pre-determined time period, and wherein the processor is operable to initiate at least one preventive action if the recommended one or more corrective measures are not implemented by the driver within the pre-determined time period based on the alert, wherein the alert is customized by the processor using a prerecorded voice associated with a user designated to oversee or supervise the driver to emphasize an urgency of implementing the one or more corrective measures within the pre-determined time period for improving safety; and
executing, using the processor, the at least one preventive action if the one or more corrective measures are not implemented by the driver within the pre-determined time period, wherein the at least one preventive action, upon execution, manipulates the two-wheeled vehicle to mitigate a risk associated with the unsafe driving behavior.

2. The method of claim 1, wherein the vehicle-related data and the driver-related data are captured by a plurality of capturing devices equipped on the two-wheeled vehicle.

3. The method of claim 2, wherein the plurality of capturing devices is selected from a set of capturing devices consisting of: a high-resolution imaging device, an infrared imaging device, a gyroscope, a LiDAR device, a sonar device, a radar device, a GPS device, an accelerometer, and an audio capturing device.

4. The method of claim 1, wherein the vehicle-related data comprises data selected from a set of information consisting of: current speed, acceleration, direction, speed variations, location changes, current location, and mapping of a roadway along a path of the two-wheeled vehicle.

5. The method of claim 1, wherein the driver-related data comprises data selected from a set of information consisting of: a lane deviation frequency, a response time to traffic signals, adherence to traffic rules, a level of attentiveness, engagement with distracting devices, and use of a protective gear.

6. The method of claim 1, wherein the at least one driver attribute associated with the unsafe driving behavior is selected from a set of driver attributes consisting of: frequent lane changes, lane changes not allowing sufficient distance between vehicles, exceeding speed limits, tailgating, neglecting to wear a protective gear, and engaging with distracting devices during the trip.

7. The method of claim 1, wherein at least one of the one or more corrective measures is selected from a set of corrective measures consisting of: reducing a speed of the two-wheeled vehicle, ensuring wearing of a protective gear, and discontinuing a use of distracting devices.

8. The method of claim 1, wherein the at least one preventive action is selected from a set of preventative actions consisting of: initiating a stopping procedure of the two-wheeled vehicle, changing gears of the two-wheeled vehicle, activating automatic emergency braking, adjusting a speed of the two-wheeled vehicle, and disabling one or more vehicle functionalities until the one or more corrective measures are implemented.

9. The method of claim 1, wherein the step of executing the at least one preventive action employs at least one model selected from a set of models consisting of: an artificial intelligence (AI) model and a machine learning (ML) model for executing the at least one preventive action if the one or more corrective measures are not implemented by the driver within the pre-determined time period.

10. A driver risk mitigation system for two-wheeled vehicles, the system comprising:
a plurality of sensors configured to capture vehicle-related data and driver-related data pertaining to a two-wheeled vehicle and a driver operating the two-wheeled vehicle, respectively; and
a processor operating in communication with the plurality of sensors, wherein the processor is configured to:
analyze the captured vehicle-related data to detect commencement of a trip by the driver of the two-wheeled vehicle,
process the driver-related data to identify at least one driver attribute associated with an unsafe driving behavior based on at least one predefined rule,
send an alert to an output device for the driver upon the identification of the at least one driver attribute, wherein the alert comprises recommendations for one or more corrective measures for the driver to be implemented within a preset duration, and wherein the processor is operable to initiate at least one preventive action if the recommended one or more corrective measures are not implemented by the driver within the preset duration based on the alert, wherein the alert is customized by the processor using a prerecorded voice associated with a user designated to oversee or supervise the driver to emphasize an urgency of implementing the one or more corrective measures within the preset duration for improving safety,
ascertain, after the preset time duration has elapsed, whether the driver has implemented the one or more corrective measures, and
execute the at least one preventive action upon ascertaining that the driver has not implemented the one or more corrective measures, wherein the at least one preventive action, upon execution, manipulates the two-wheeled vehicle to mitigate a risk associated with the unsafe driving behavior.

11. The system of claim 10, wherein the processor is further configured to provide an option to the user to remotely disable the two-wheeled vehicle.

12. The system of claim 10, wherein the vehicle-related data comprises data selected from a set of information consisting of: current speed, acceleration, direction, speed variations, location changes, current location, and mapping of a roadway along a path of the two-wheeled vehicle.

13. The system of claim 10, wherein the driver-related data comprises data selected from a set of information consisting of: a lane deviation frequency, a response time to traffic signals, adherence to traffic rules, a level of attentiveness, engagement with distracting devices, and use of a protective gear.

14. The system of claim 10, wherein the at least one driver attribute associated with the unsafe driving behavior is selected from a set of driver attributes consisting of: frequent lane changes, lane changes not allowing sufficient distance between vehicles, exceeding speed limits, tailgating, neglecting to wear a protective gear, and engaging with distracting devices during the trip, and ignoring traffic signs and signals.

15. The system of claim 10, wherein at least one of the one or more corrective measures is selected from a set of corrective measures consisting of: reducing a speed of the two-wheeled vehicle, ensuring wearing of a protective gear, and discontinuing a use of distracting devices.

16. The system of claim 10, wherein the at least one preventive action is selected from a set of preventative actions consisting of: initiating a stopping procedure of the two-wheeled vehicle, changing gears of the two-wheeled vehicle, activating automatic emergency braking, adjusting a speed of the two-wheeled vehicle, and disabling one or more vehicle functionalities until the one or more corrective measures are implemented.

17. The system of claim 10, wherein the processor is further configured to, upon ascertaining that the driver has not implemented the one or more corrective measures, send an additional alert to the user to notify the user about the unsafe driving behavior of the driver, and wherein the additional alert comprises a detailed analysis report pertaining to the at least one driver attribute associated with the unsafe driving behavior.

18. The system of claim 10, wherein the processor is further configured to transmit the captured vehicle-related data and the driver-related data pertaining to the two-wheeled vehicle and the driver of the two-wheeled vehicle, respectively, to a remote server.

19. The system of claim 10, wherein the processor is further configured to execute the at least one preventive action using a model selected from a set of models consisting of: an artificial intelligence (AI) model and a machine learning (ML) model.

20. The system of claim 10, wherein the processor is further configured to employ at least one model selected from a set of models consisting of: an artificial intelligence (AI) model and a machine learning (ML) model for executing the at least one preventive action if the one or more corrective measures are not implemented by the driver within the preset time duration.
